(19) United States
(12) Patent Application Publication
(10) Pub. No.: US 2018/0027557 A1
(43) Pub. Date: Jan. 25, 2018

(54) Broadcast Channel Reception in Multi-subscription Multi-standby Communication Devices

(71) Applicant: QUALCOMM Incorporated, San Diego, CA (US)

(72) Inventors: Nikhil Challa, San Diego, CA (US); Krishna Ram Budhathoki, San Diego, CA (US)

(21) Appl. No.: 15/722,289

(22) Filed: Oct. 2, 2017

Related U.S. Application Data
(63) Continuation of application No. 14/755,149, filed on Jun. 30, 2015.

(51) Int. Cl. H04W 72/04; H04W 72/12; H04W 4/22; H04W 76/00; H04W 4/06; H04W 60/00

(52) U.S. Cl. CPC H04W 72/0446; H04W 76/007; H04W 76/002; H04W 4/06; H04W 72/1263; H04W 4/22; H04W 60/005

(57) ABSTRACT

Embodiments include systems and methods for managing tune-aways in a multi-subscription multi-standby communication device. A device processor may determine whether the multi-subscription multi-standby communication device is conducting an active communication session on a first network. The device processor may determine whether broadcast channel data is received over a broadcast channel of a second network in response to determining the multi-subscription device is conducting the active communication session on the first network. The device processor may calculate a periodicity of the broadcast over the broadcast channel in response to determining that the broadcast channel data is received over the broadcast channel. The device processor may schedule one or more tune-aways to the broadcast channel based on the calculated periodicity of the broadcast of the broadcast, and the device processor may perform the one or more tune-aways from the first network to the broadcast channel of the second network.

### RELATED APPLICATIONS

This application is a continuation of U.S. patent application Ser. No. 14/755,149 entitled “Broadcast Channel Reception in Multi-subscription Multi-standby Communication Devices” filed Jun. 30, 2015, the entire contents of which are incorporated herein by reference.

### BACKGROUND

Wireless devices having multiple subscriber identity modules (SIMs) may communicate with two or more cells of a wireless network. Some multi-subscription multi-standby communication devices may allow two or more network interfaces or subscriber identity modules (SIMs) to share a single radio frequency (RF) resource (e.g., dual-SIM dual-standby, or “DSDS” devices). However, the RF resource in such devices can only tune to a single network at a time. The multi-subscription multi-standby communication device may employ a “tune-away” procedure to monitor multiple interfaces in a standby mode by tuning to one network in a primary cell, quickly tuning away to the second network in a second cell for a short time, and then tuning back to the first network to continue a voice or data call. This tune-away procedure may allow the multi-subscription multi-standby communication device to monitor for pages or other indications of incoming messages or data received on the second network. However, tuning away to another network may interrupt communications with the first network and may reduce throughput of communications between the first network and the multi-subscription multi-standby communication device.

Cell broadcast is a mobile communication network feature that enables a communication network to broadcast a point-to-area message to a plurality of mobile terminals in communication with one or more cells of the communication network. Cell broadcast may be used to transmit important messages to mobile communication devices in a wide area, such as safety or emergency broadcasts, by a communication network that supports a public warning system, such as the Commercial Mobile Alert System (CMAS), the Earthquake and Tsunami Warning System (ETWS), Wireless Emergency Alerts (WEA), the Personal Localized Alerting Network (PLAN), and other similar public warning systems. A communication network may transmit such public warning system information and other cell broadcast messages on a cell broadcast channel.

Because the multi-subscription multi-standby communication device may only use the single RF resource to communicate with one communication network at a time, communication with one network may lead to missed communication or loss of data from the second network. For example, when the multi-subscription multi-standby communication device is on a call or data communication session on a first network, tuning away from the first network to receive and decode broadcast channel data from a second network may interrupt the reception of data on the first network, which may degrade data throughput for any application or communication session using the first network.

### SUMMARY

The various embodiments include methods and multi-subscription multi-standby communication devices implementing methods for managing tune-aways. The various methods may include determining whether the multi-subscription multi-standby communication device is conducting an active communication session on a first network, determining whether broadcast channel data is received over a broadcast channel of a second network in response to determining the multi-subscription multi-standby communication device is conducting an active communication session on the first network, calculating a periodicity of a broadcast of the broadcast channel data in response to determining that the broadcast channel data is received over the broadcast channel, scheduling one or more tune-aways from the first network to the broadcast channel of the second network based on the calculated periodicity of the broadcast, and performing the one or more tune-aways from the first network to the broadcast channel of the second network. In some embodiments, the method may further include scheduling one or more tune-aways to the broadcast channel based on a selected time interval in response to determining that broadcast channel data is not received over the broadcast channel.

In some embodiments, scheduling one or more tune-aways from the first network to the broadcast channel of the second network based on a selected time interval in response to determining that the broadcast channel data is not received over the broadcast channel may include scheduling one or more tune-aways to the broadcast channel using a selected time interval. In some embodiments, scheduling one or more tune-aways from the first network to the broadcast channel of the second network based on a selected time interval in response to determining that the broadcast channel data is not received over the broadcast channel may include scheduling one or more tune-aways to the broadcast channel for a selected duration of time at a selected interval of time. In some embodiments, the selected duration of time may be shorter than the selected interval of time.

In some embodiments, scheduling one or more tune-aways from the first network to the broadcast channel of the second network based on a selected time interval in response to determining that the broadcast channel data is not received over the broadcast channel may include disabling broadcast channel activity for a first period of time and resuming broadcast channel activity for a second period of time.

In some embodiments, calculating a periodicity of the broadcast of the broadcast channel data in response to determining that broadcast channel data is received over a broadcast channel may include determining whether the periodicity of the broadcast can be calculated, and calculating the periodicity of the broadcast of the broadcast channel data in response to determining that the periodicity of the broadcast of the broadcast channel data can be calculated. In some embodiments, the method may further include scheduling one or more tune-aways from the first network to the broadcast channel of the second network using a selected time interval in response to determining that the periodicity of the broadcast of the broadcast channel data cannot be calculated.

In some embodiments, the method may further include determining whether the multi-subscription multi-standby communication device has received broadcast channel data of a next-scheduled tune-away from the first network to the broadcast channel of the second network, and preventing the next-scheduled tune-away in response to determining that the multi-subscription multi-standby communication device has received the broadcast channel data of the next-scheduled tune-away. In some embodiments, the method may further include receiving every broadcast of the broadcast channel in response to determining that the multi-subscription multi-standby communication device is not conducting the active communication session on the first network. In some embodiments, the method may further include scheduling one or more tune-aways from the first network to the broadcast channel of the second network to receive most broadcasts of the broadcast channel

Various embodiments further include a mobile computing device having a memory, a radio frequency (RF) resource, and a processor coupled to the memory and the RF resource and configured with processor executable instructions to perform operations of the methods described above. Various embodiments include a mobile computing device having means for performing functions of the methods described above. Various embodiments include a non-transitory processor-readable storage medium having stored thereon processor-executable instructions configured to cause a processor of a mobile computing device to perform operations of the methods described above.

### BRIEF DESCRIPTION OF THE DRAWINGS

The accompanying drawings, which are incorporated herein and constitute part of this specification, illustrate exemplary embodiments. Together with the general description given above and the detailed description given below, the drawings serve to explain features of the various embodiments, and not to limit the various embodiments.

FIG. 1 is a component block diagram of a communication system suitable for use with various embodiments.

FIG. 2 is a component block diagram of a multi-subscription multi-standby communication device according to various embodiments.

FIG. 3 is a process flow diagram illustrating a method for managing broadcast channel tune-aways in a multi-subscription multi-standby communication device according to various embodiments.

FIG. 4 is a process flow diagram illustrating another method for managing broadcast channel tune-aways in a multi-subscription multi-standby communication device according to various embodiments.

FIG. 5 is a component block diagram of a mobile communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods implemented multi-subscription multi-standby communication devices that enable reception of cell broadcasts on a first network while reducing degradation of throughput of data of an active communication session on a second network by appropriately scheduling tune-aways to the first network.

The term “multi-subscription multi-standby (MSMS) communication device” is used herein to refer to any one or all of cellular telephones, smailphones, personal or mobile multi-media players, personal data assistants, laptop computers, tablet computers, smartbooks, palmtop computers, wireless electronic mail receivers, multimedia Internet enabled cellular telephones, wireless gaming controllers, and similar electronic devices and portable computing platforms that include a programmable processor, a memory, and a shared RF resource and are configured to support two or more subscriptions. Various embodiments may be particularly useful in any communication devices that can support multiple wireless wide area network subscriptions and receive cell broadcasts.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on an MSMS communication device and the MSMS communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

Multi-subscription communication devices that allow two or more network interfaces or SIMs to share a single RF resource are referred to as multi-subscription multi-standby communication devices. The RF resource in such devices can only tune to a single network at a time. To support multiple subscriptions, a multi-subscription multi-standby communication device may employ a “tune-away” procedure to monitor multiple interfaces when the multi-subscription multi-standby communication device is tuned to a first network (i.e., tuned to a carrier signal associated with the first network), quickly tuning away to a second network for a short time (i.e., tuning to another carrier signal of the second network), and then tuning back to the first network to continue a voice or data call. This tune-away procedure allows the multi-subscription multi-standby communication device to support an active call on a first subscription with a first network while monitoring for pages or other indications of incoming messages or data on a second subscription received from a second network.

References to “first network,” “first subscription,” “second network” and “second subscription” are arbitrary and are used to refer to two or more subscriptions/networks generally because at any given time either subscription/network may be in an active mode (on an active voice or data call) or a standby mode. For example, during one minute a GSM subscription with a GSM network may be on an active data call (and thus a “first subscription) while a WCDMA subscription with a WCDMA network is in the standby mode (and thus a “second” subscription), and during the next minute the WCDMA subscription may enter an active data call (becoming the “first” subscription) and the GSM subscription may enter the standby mode (becoming the “second” subscription). Also, references to “first” and “second” subscriptions and networks are not intended to imply that the embodiments are limited to two subscriptions sharing one RF resource, because three or more subscriptions may share one RF resource provided that only one subscription can use the RF resource at a time. Third and fourth subscriptions would behave similar to a second subscription. Therefore, in the interest of brevity, operations of subscriptions in the standby mode that share the RF resource during tune-away periods are described generally with reference to the “second” subscription.

One type of incoming information that the multi-subscription multi-standby communication device may receive from the second network includes a cell broadcast. Cell broadcast is a mobile communication network feature that enables a communication network to broadcast a point-to-area message to a plurality of mobile terminals in communication with one or more cells of the communication network. A communication network may transmit public warning system information and other cell broadcast messages on a cell broadcast channel Cell broadcast may be used to transmit safety alerts, emergency broadcasts, and other important messages to mobile communication devices in a wide area. Examples of public warning systems include the Commercial Mobile Alert System (CMAS), the Earthquake and Tsunami Warning System (ETWS), Wireless Emergency Alerts (WEA), and the Personal Localized Alerting Network (PLAN).

A communication network may use a variety of cell broadcast mechanisms, which may depend on a particular radio access technology (RAT). Examples of RATs include Long Term Evolution (LTE), Worldwide Interoperability for Microwave Access (WiMAX), Code Division Multiple Access (CDMA), Time Division Multiple Access (TDMA), Wideband CDMA (WCDMA), and Global Systems for Mobile Communications (GSM).

For example, a GSM network provides for a Cell Broadcast Channel (CBCH), a downlink channel used to transmit CMAS/ETWS broadcast information, which may be sent over a standalone dedicated control channel (SDCCH). CBCH decoding involves periodic decoding of certain broadcasts received over a SDCCH that a communication device may expect to contain broadcast information. The details of channels to be decoded may be provided to the multi-subscription multi-standby communication device in system information broadcast by a communication network, such as a system information block (SIB). For example, a SIB may provide information to a communication device about frequencies, channels, periodicity of broadcast, and other information that may enable the multi-subscription multi-standby communication device to receive broadcast channel data. For example, in a CBCH, a typical cell broadcast may be four frames every 51 frames, in which each frame may be approximately 4.7 ms in duration.

However, the periodicity of cell channel broadcasts may vary. For example, a CMAS message may consist of up to 15 message segments. A CMAS message may include a text message portion (e.g., a SMS text message). While communication networks generally follow a specified periodicity of sending CMAS broadcasts (such as an SMS cell broadcast), the periodicity of CMAS broadcasts is typically different from typical CBCH periodicity, for example, in part because communication networks are permitted some freedom to select a periodicity for sending CMAS broadcasts. In the case of CMAS, each message segment includes an “update number,” which is an element of a segment's payload that signifies whether any message content has been changed.

Tuning away to another network may interrupt transmissions to the first network and may reduce throughput of data transmitted between the first network and the multi-subscription multi-standby communication device. Because the multi-subscription multi-standby communication device may only use the single RF resource to communicate with one communication network at a time, communication with one network may lead to missed communication or loss of data from the second network. For example, when the multi-subscription multi-standby communication device is on a call or data communication session on a first network, tuning away from the first network to receive and decode cell broadcast data from a second network may interrupt the reception of data on the first network, which may degrade data throughput for any application or communication session using the first network.

Various embodiments enable a processor of a multi-subscription multi-standby communication device that is conducting an active communication session on a first network to schedule a tune-away to receive cell broadcast channel data from a second network in a manner that reduces degradation of throughput of data for the active communication session. For example, a multi-SIM multi-standby communication device may receive a CBCH broadcast for CMAS using GSM on a second network while the multi-SIM multi-standby communication device is also in RRC_Connected mode using LTE on a first network.

In some embodiments, the multi-subscription multi-standby communication device may determine whether the multi-subscription multi-standby communication device is conducting an active communication session using a first subscription on a first network. For example, a processor of the multi-subscription multi-standby communication device may determine whether the multi-subscription multi-standby communication device is in an RRC_Connected mode. In response to determining that the multi-subscription multi-standby communication device is conducting an active communication session on the first network, the processor may determine whether the multi-subscription multi-standby communication device has received any data (i.e., pages, messages, warnings, or another broadcast) over the broadcast channel of a second network. In some embodiments, the multi-subscription multi-standby communication device may periodically tune-away to a Cell Broadcast Channel (CBCH) to receive any data being broadcast and to determine whether a data is received over the CBCH. In some embodiments, the multi-subscription multi-standby communication device may determine whether new data has arrived. For example, the multi-subscription multi-standby communication device may determine whether a received block of data has a new or different sequence number as compared to previously received data.

In some embodiments, if the multi-subscription multi-standby communication device receives no broadcast channel data during a tune-away or no new broadcast channel data, the multi-subscription multi-standby communication device may schedule periodic tune-aways to the broadcast channel to listen for broadcast data. For example, the multi-subscription multi-standby communication device may schedule one or more tune-aways at a selected number of seconds between tune-aways. In some embodiments, the multi-subscription multi-standby communication device may schedule tune-aways to the broadcast channel for a selected duration of time (e.g., a selected number of milliseconds) at a selected interval of time (e.g., a selected number of seconds). In some embodiments, the selected duration of time may be predefined shorter than the selected interval of time. In some embodiments, with the selected duration of time is X milliseconds, and the selected interval of time as Y seconds, X may be substantially less than Y (e.g., X<<Y).

In some embodiments, in response to determining that no broadcast channel data is received during a tune-away or that no new broadcast channel data is received, the multi-subscription multi-standby communication device processor may attempt to calculate a periodicity of a broadcast over the broadcast channel. For example, the processor may attempt to calculate periodicity of a broadcast channel broadcast based on arrival times of two or more broadcast channel data blocks. Typically, a communication network that transmits broadcast data does not provide separate information or signaling about the transmission rate of broadcast data segments. The multi-subscription multi-standby communication device processor may therefore calculate a segment transmission rate, which the processor may use to reduce a number of tune-aways to the broadcast channel In some embodiments, in response to determining that the periodicity cell broadcast segment transmissions can be calculated, the processor may schedule one or more tune-aways to the broadcast channel based on the calculated periodicity. In some embodiments, in response to determining that the periodicity cell broadcast segment transmissions cannot be calculated, the processor may schedule one or more tune-aways to the broadcast channel using a predefined short time interval (e.g., every 2-3 seconds), to avoid missing any broadcast channel data.

Because of the importance of the content of such broadcast data, the communication network may repeatedly transmit the same broadcast data in order to increase the probability of reception. Thus, in some embodiments, the multi-subscription multi-standby communication device may determine whether it has already received broadcast data that is anticipated in the next scheduled cell broadcast. For example, a communication network may transmit broadcast data in a sequence of blocks, and the multi-subscription multi-standby communication device may receive and determine the sequence number of each block of broadcast data. The multi-subscription multi-standby communication device may determine whether the multi-subscription multi-standby communication device has already received a block of data that will be transmitted again in the next scheduled cell broadcast. In response to determining that the multi-subscription multi-standby communication device has already received broadcast data that is anticipated in the next scheduled cell broadcast, the processor may not perform, or may prevent the performance of, the next scheduled tune-away. For example, the multi-subscription multi-standby communication device may skip the next scheduled tune-away to the second network.

In some embodiments, each page of a CBCH message that may be sent by a communication network may include a fixed block of 88 octets. The 88 octets may be formatted as illustrated in Table 1 below:

TABLE 1

| Octet | |
|---|---|
| Number (s) | Field |
| 1-2 | Serial Number |
| 3-4 | Message Identifier |
| 5 | Data Coding Scheme |
| 6 | Page Parameter |
| 7-88 | Content of Message |

Upon decoding the page parameter of the CBCH message, the processor of the multi-subscription multi-standby communication device may determine a number of expected CBCH pages. The processor may use the number of expected CBCH pages to determine, among other things, whether all of the expected CBCH pages have been received (i.e., the end of all expected page messages). In some embodiments, the device processor may not perform, or may prevent the performance of, a next scheduled tune-away (i.e., the processor may skip the next scheduled tune-away to the second network). So if the device processor detects the end of all pages, the next scheduled tune away can be prevented. The page parameter may be coded as two 4-bit fields. The first field (bits 0-3) may indicate a binary value of a total number of pages in the CBCH message, and the second field (bits 4-7) may indicate a binary value of a page number within that sequence. In some embodiments, the coding may start at 0001, with 0000 reserved. In some embodiments, if the device processor receives the code 0000 in either the first field or the second field, then the device processor may treat the CBCH message in the same manner as a message with page parameter 0001 (i.e. as a single page message).

The various embodiments may be utilized in a variety of technical contexts. For example, a multi-subscription multi-standby communication device may be primarily connected to (e.g., “camped on”) a first RAT, such as WCDMA or LTE (specified in 3GPP standards); and Single Carrier Radio Transmission Technology (1×RTT), Evolution-Data Optimized (EVDO), High Data Rate (HDR), or Ultra Mobile Broadband (UMB) (as specified in 3GPP2 standards); WiMAX (as specified in IEEE standards). Similarly, the multi-subscription multi-standby communication device may receive cell broadcast services over another communication network including Cell Broadcast (i.e., CBCH)-based services, Multimedia Broadcast Media Services (MBMS), Enhanced MBMS (eMBMS) (such as may be available over LTE), Cell Broadcast Services (CBS), and other cell broadcast services that may be utilized by communication networks according to one or more RATs.

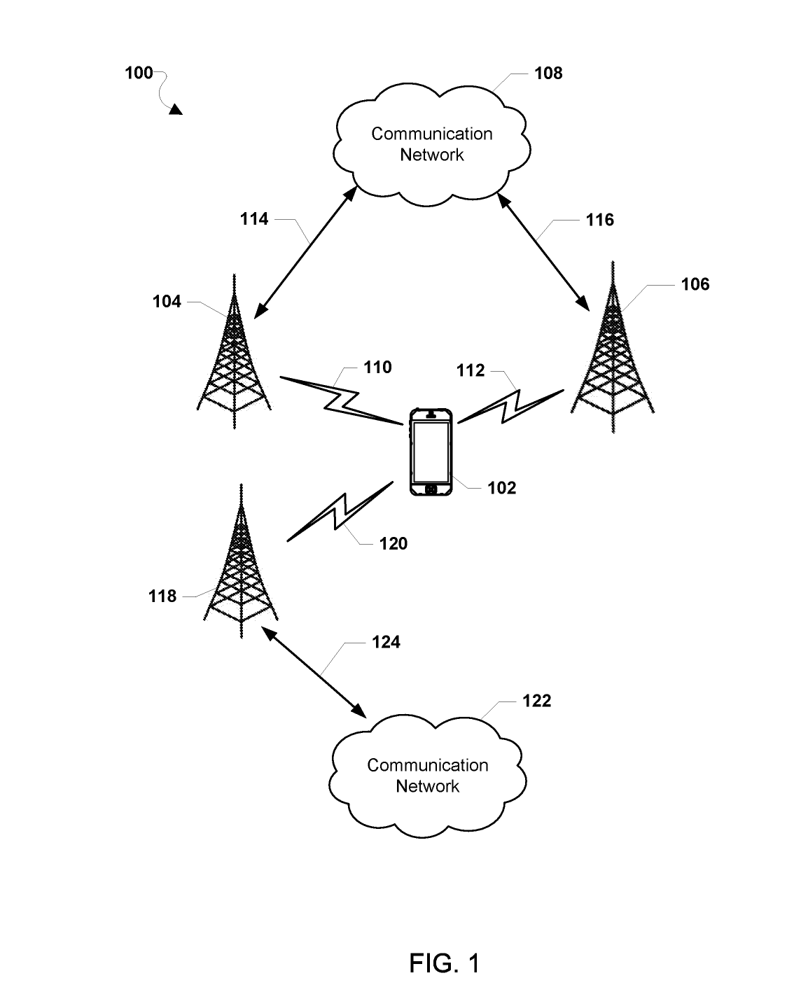

Various embodiments may be implemented in multi-subscription multi-standby communication devices that may operate within a variety of communication systems particularly systems that include at least two communication networks. FIG. 1 illustrates a communication system 100 suitable for use with various embodiments. A multi-subscription multi-standby communication device 102 may communicate with a communication network 108, which may include a plurality of base stations, such as base stations 104, 106. The multi-subscription multi-standby communication device 102 may also communicate with a communication network 122, which may include a base station 118. The base station 104 may communicate with the communication network 108 over a wired or wireless communication link 114, which may include fiber optic backhaul links, microwave backhaul links and other similar communication links. The base station 106 may communicate with the communication network 108 over a wired or wireless communication link 116 similar to the communication link 114. The base station 118 may communicate with the communication network 122 over a wired or wireless communication link 124 similar to the communication link 114. In some embodiments, each communication network 108, 122 may include a mobile telephony communication network. The multi-subscription multi-standby communication device 102 may communicate with the base station 104 over a wireless communication link 110, with the base station 106 over a wireless communication link 112, and with the base station 118 over a wireless communication link 120.

Each of the communication networks 108, 122 may support communications using one or more RATs, and each of the wireless communication links 110, 112, and 120 may include cellular connections that may be made through two-way wireless communication links using one or more RATs. The communication networks 108, 122 may also be configured to transmit cell broadcast information using a system such MBMS, eMBMS, CBS, CMAS, ETWS, WEA, PLAN, or another cell broadcast system.

While the communication links 110, 112, and 120 are illustrated as single links, each of the communication links 110, 112, and 120 may include a plurality of carrier signals, frequencies, or frequency bands, each of which may include a plurality of logical channels. Additionally, each of the communication links 110, 112, and 120 may utilize more than one RAT. For example, the multi-subscription multi-standby communication device 102 may receive a first carrier signal from the base station 104 and a second carrier signal from the base station 106, and the multi-subscription multi-standby communication device 102 may determine a throughput each of the carrier signals. As another example, the multi-subscription multi-standby communication device 102 may receive the first carrier signal and the second carrier signal from the base station 104 or the base station 106. The multi-subscription multi-standby communication device 102 may use a receiver or transceiver associated with the carrier signal having the lowest throughput from among the first carrier signal and the second carrier signal to perform the tune-away procedure. In some embodiments, the first and second carrier signals may use the same RAT. In some embodiments, the multi-subscription multi-standby communication device 102 may also perform a tune-away procedure using a second RAT (e.g., tuning away from a WCDMA network to a GSM network).

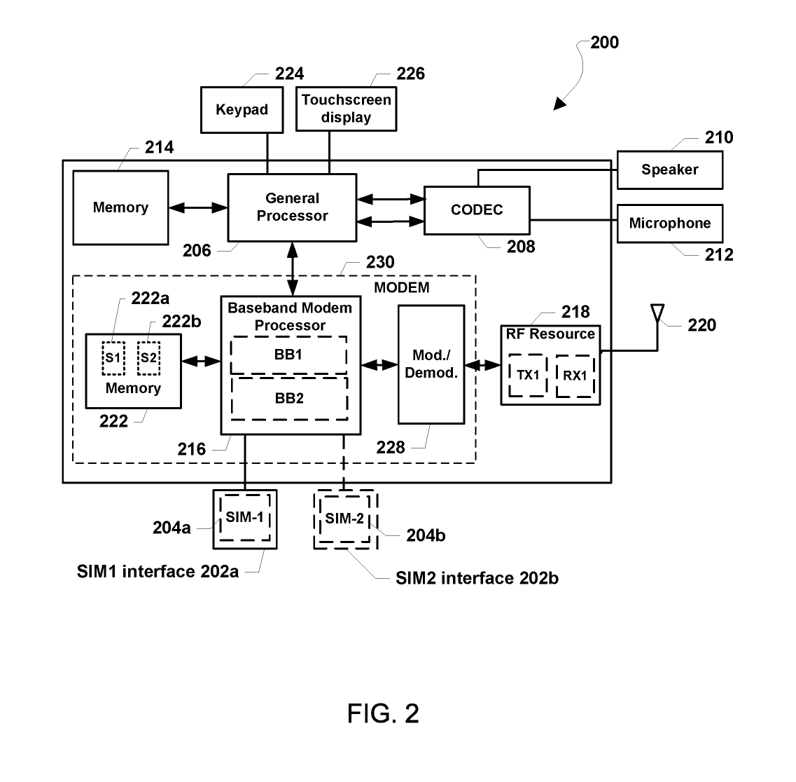

FIG. 2 is a component block diagram of a multi-subscription multi-standby communication device 200 suitable for implementing various embodiments. With reference to FIGS. 1 and 2, in various embodiments, the multi-subscription multi-standby communication device 200 may be similar to the multi-subscription multi-standby communication device 102. The multi-subscription multi-standby communication device 200 may include a first SIM interface 202a, which may receive a first identity module SIM-1 204a that is associated with a first subscription. The multi-subscription multi-standby communication device 200 may optionally also include a second SIM interface 202b, which may receive a second identity module SIM-2 204b that is associated with a second subscription.

A SIM in various embodiments may be a Universal Integrated Circuit Card (UICC) that is configured with SIM and/or USIM (Universal Subscriber Identity Module) applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

The multi-subscription multi-standby communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The general purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to an RF resource 218 for transmission. The modulator/demodulator 228 may also extract an information-bearing signal from a modulated carrier wave received from the RF resource 218, and may provide the demodulated signal to the baseband modem processor 216. The modulator/demodulator 228 may be or include a digital signal processor (DSP).

The baseband modem processor 216 may read and write information to and from the memory 222. The memory 222 may also store instructions associated with a protocol stack, such as protocol stack S1 222a and protocol stack S2 222b. The protocol stacks S1 222a, S2 222b generally include computer executable instructions to enable communication using a radio access protocol or communication protocol. Each protocol stack S1 222a, S2 222b typically includes network protocol layers structured hierarchically to provide networking capabilities. The modem 230 may include one or more of the protocol stacks S1 222a, S2 222b to enable communication using one or more RATs. The protocol stacks S1 222a, S2 222b may be associated with a SIM card (e.g., SIM-1 204a, SIM-2 204b) configured with a subscription. For example, the protocol stack S1 222a and the protocol stack S2 222b may be associated with the SIM-1 204a. The illustration of only two protocol stacks S1 222a, S2 222b is not intended as a limitation, and the memory 222 may store more than two protocol stacks (not illustrated).

Each SIM and/or RAT in the multi-subscription multi-standby communication device 200 (e.g., SIM-1 204a, SIM-2 204b) may be coupled to the modem 230 and may be associated with or permitted to use the RF resource 218. In some embodiments, the RF resource 218 may use a common baseband modem processor 216 to perform baseband/modem functions for all RATs on the multi-subscription multi-standby communication device. In some embodiments, the RF resource 218 may include the physically or logically separate baseband processors (e.g., BB1, BB2).

The RF resource 218 may include transceivers associated with one or more RATs and may perform transmit/receive functions for the mobile communication device 200 on behalf of their respective RATs. The RF resource 218 may include separate transmit and receive circuitry. The RF resource 218 may be coupled to a wireless antenna (e.g., the wireless antenna 220). The RF resource 218 may also be coupled to the modem 230 (e.g., via the modulator/demodulator 228, or alternatively via the baseband modem processor 216 or another component).

In some embodiments, the general purpose processor 206, memory 214, baseband processor(s) 216, and the RF resource 218 may be included in the mobile communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the mobile communication device 200 may include, but are not limited to, a keypad 224 and a touchscreen display 226.

In some embodiments, the keypad 224, the touchscreen display 226, the microphone 212, or a combination thereof may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the multi-subscription multi-standby communication device 200 to enable communication between them.

Functioning together, the two SIMs 204a, 204b, the baseband processor(s) 216, RF resource 218, and the antenna 220 may enable communications on two or more RATs. For example, one SIM, baseband processor and RF resource may be configured to support two different RATs. In other embodiments, more RATs may be supported on the multi-subscription multi-standby communication device 200 by adding more SIM cards, SIM interfaces, RF resources, and antennas for connecting to additional mobile networks.

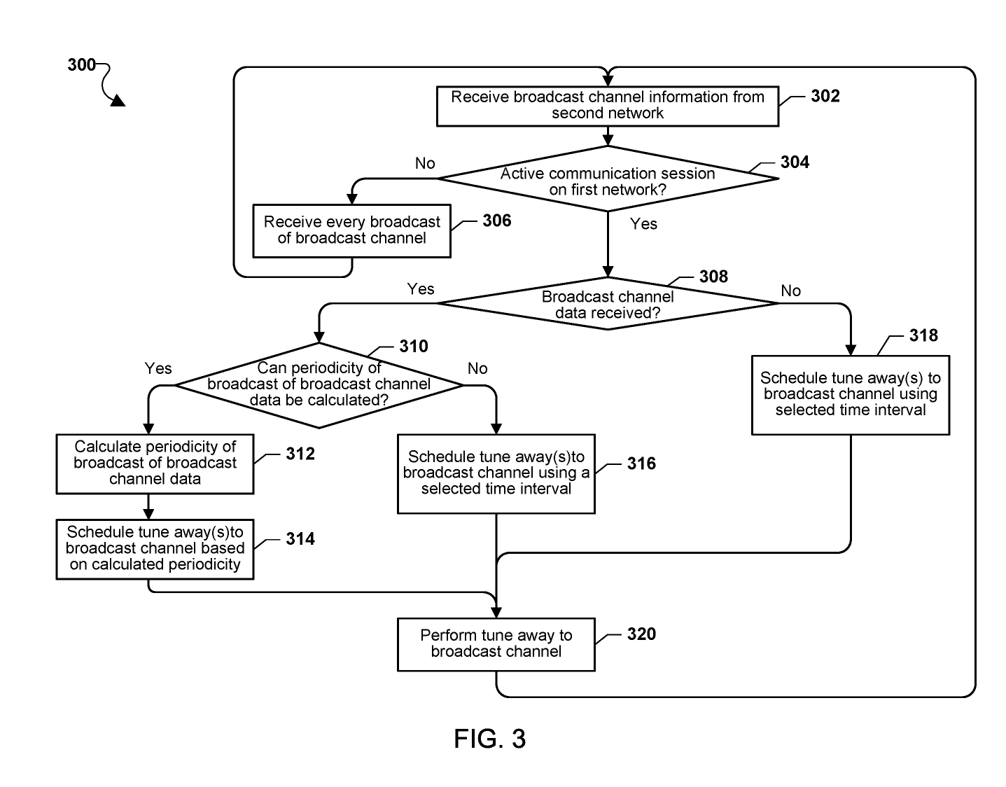

FIG. 3 illustrates a method 300 for managing tune-away in a multi-subscription wireless device (e.g., the multi-subscription multi-standby communication device 102, 200 in FIGS. 1-2) according to some embodiments. With reference to FIGS. 1-3, the method 300 may be implemented by a processor (e.g., the general purpose processor 206, the baseband processor 216, a separate controller, and/or the like) of the multi-subscription multi-standby communication device (i.e., a device processor).

In block 302, the device processor may receive broadcast channel information from a second network. For example, the multi-subscription multi-standby communication device may receive one or more SIBs, master information blocks (MIBs), or other system information from a second network. The broadcast channel information may provide information that may enable the multi-subscription multi-standby communication device to receive broadcast channel data from the second network, including frequencies, channels, broadcast periodicity (whether reliable or not), and other such information.

In determination block 304, the device processor may determine whether the multi-subscription multi-standby communication device is conducting an active communication session on a first network. For example, the multi-subscription multi-standby communication device may be conducting a voice call, a data communication session, or another active communication session using a first subscription on a first network. As an example, the device processor may determine whether the multi-subscription multi-standby communication device is in an RRC_Connected mode on the first network.

In some embodiments, the device processor may be triggered to determine whether the multi-subscription multi-standby communication device is conducting an active communication session on the first network by a change in the connection status of the multi-subscription multi-standby communication device (e.g., when the multi-subscription multi-standby communication device changes from an RRC_Idle mode to the RRC_Connected mode).

In response to determining that the multi-subscription multi-standby communication device is not conducting an active communication session on the first network (i.e., determination block 304=“No”), the device processor may receive every broadcast (or substantially every broadcast) of the broadcast channel of the second network in block 306. For example, since reception of every broadcast of the broadcast channel will not interfere with any communication session on the first network, the device processor may frequently monitor the broadcast channel for incoming information. In some embodiments, the device processor may instruct the multi-subscription multi-standby communication device to primarily receive broadcast channel information (i.e., to tune to the broadcast channel) and to periodically monitor the first network for an indication of incoming messages, data, call requests, or other notifications or data from the first network.

In response to determining that the multi-subscription multi-standby communication device is conducting an active communication session on the first network (i.e., determination block 304=“Yes”), the device processor may determine whether broadcast channel data is received by the multi-subscription multi-standby communication device over the broadcast channel in determination block 308. In some embodiments, the device processor may determine whether the multi-subscription multi-standby communication device has received any broadcast channel data (i.e., messages, warnings, or another broadcast) over the broadcast channel In some embodiments, the multi-subscription multi-standby communication device may periodically tune-away to the broadcast channel to receive any data being broadcast and to determine whether a data is received over the broadcast channel. In some embodiments, the multi-subscription multi-standby communication device may determine whether new broadcast channel data has arrived. For example, the multi-subscription multi-standby communication device may determine whether a received block of data has a new or different sequence number as compared to previously-received broadcast channel data.

In response to determining that broadcast channel data (or new broadcast channel data) is not received (i.e., determination block 308=“No”), the device processor may schedule one or more tune-aways to the broadcast channel using a selected time interval in block 318. In some embodiments, the device processor may enter a “semi-sleep mode” in which the device processor may schedule one or more tune-aways to the broadcast channel using a selected time interval. In some embodiments, the multi-subscription multi-standby communication device may schedule tune-aways to the broadcast channel for a selected duration of time (e.g., a selected number of milliseconds) at a selected interval of time (e.g., a selected number of seconds). In some embodiments, the selected duration of time may be defined shorter than the selected interval of time. In some embodiments, if the selected duration of time is X milliseconds, and the selected interval of time as Y seconds, X may be substantially less than Y (i.e., X<<Y). In some embodiments, the selected time interval and/or the selected duration of time may be based on the received broadcast channel information. In some embodiments, the device processor may disable broadcast channel reception and/or decoding for a first period of time and resume broadcast channel reception and/or decoding for a second period of time. Based on the schedule the device processor may perform a tune away to the broadcast channel in block 320 and receive broadcast channel information from the second network, before repeating the operations of blocks 302-320.

In response to determining that broadcast channel data (or new broadcast channel) is received by the multi-subscription multi-standby communication device (i.e., determination block 308=“Yes”), the device processor may determine whether the device processor can calculate a periodicity of broadcasts of the cell broadcast channel data in determination block 310. For example, the device processor may attempt to calculate a periodicity of the broadcasts based on arrival times of two or more broadcast channel data blocks and/or two or more information blocks from the broadcast channel Typically, a communication network that transmits broadcast data does not provide separate information or signaling about a transmission rate of broadcast data segments, and thus the device processor may calculate the periodicity or segment transmission rate based on received broadcast channel data and/or broadcast channel information received over the broadcast channel.

In response to determining that the device processor can calculate the periodicity of broadcasts of the cell broadcast channel data (i.e., determination block 310=“Yes”), the device processor may calculate a periodicity of the broadcast of broadcast channel data (e.g., over the broadcast channel) in block 312. In some embodiments, the device processor may instruct the reception of at least two broadcast data segments to calculate the periodicity of the broadcast. In some embodiments, in order to receive more information and calculate a more accurate periodicity, the device processor may instruct the reception of more than two broadcast data segments. In block 314, the device processor may then schedule one or more tune-aways to the broadcast channel based on the calculated periodicity. In some embodiments, the device processor may enter a “reduced periodicity” mode in which the device processor schedules a minimum number of tune-aways based on the calculated periodicity, in order to reduce a negative impact of the broadcast channel tune-aways to the second network on the active communication session on the first network.

Based on the schedule, the device processor may perform a tune-away to the broadcast channel in block 320 and receive broadcast channel information from the second network in block 302, before repeating the operations of blocks 302-320.

In response to determining that the device processor cannot calculate the periodicity of broadcast of the cell broadcast channel data (i.e., determination block 310=“No), the device processor may schedule one or more tune-aways to the broadcast channel using a selected time interval in block 316. In some embodiments, the selected time interval may be a predefined relatively short time period, such as a period of 2-3 seconds, so that the multi-subscription multi-standby communication device may avoid missing any broadcast channel data. Based on the schedule, the device processor may perform a tune-away to the broadcast channel in block 320 and receive broadcast channel information from the second network in block 302, before repeating the operations of blocks 302-320.

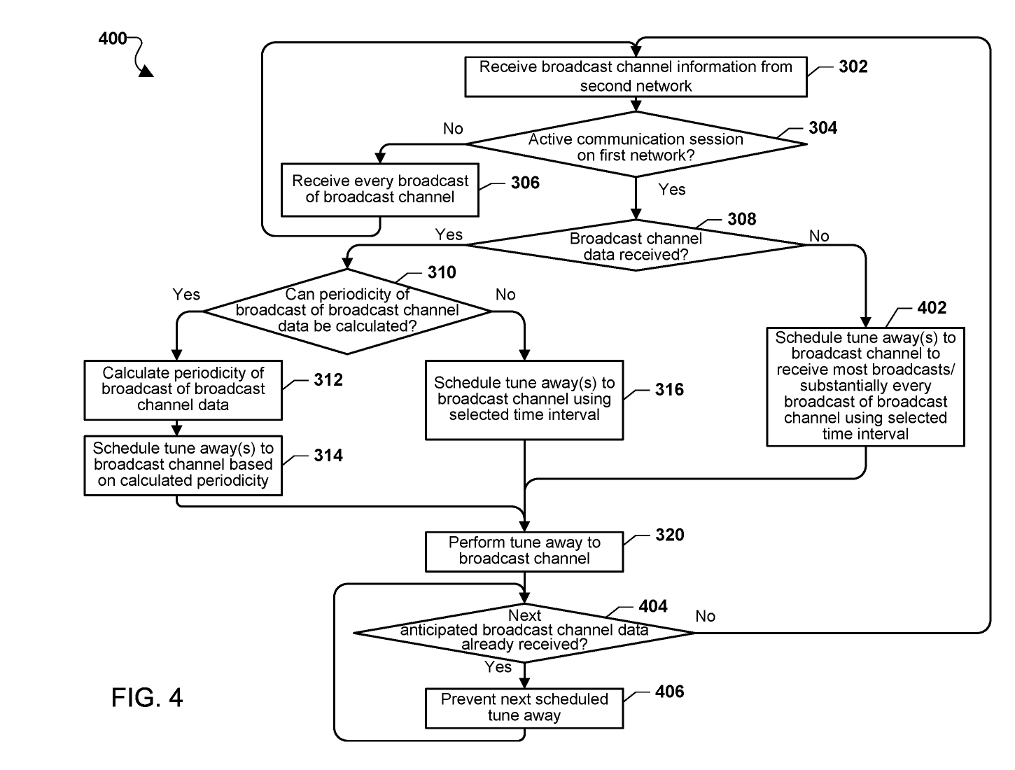

FIG. 4 illustrates a method 400 for managing tune-away in a multi-subscription wireless device (e.g., the multi-subscription multi-standby communication device 102, 200 in FIGS. 1-2) according to some embodiments. With reference to FIGS. 1-4, the method 400 may be implemented by a processor (e.g., the general purpose processor 206, the baseband processor 216, a separate controller, and/or the like) of the multi-subscription multi-standby communication device (i.e., a device processor). In blocks 302-320, the device processor may perform operations of like numbered blocks of the method 300.

In response to determining that the multi-subscription multi-standby communication device has not received broadcast channel data (i.e., determination block 308=“No”), the device processor may schedule one or more tune-aways to the broadcast channel to receive every possible broadcast (or most of the broadcasts, or a majority of the broadcasts, or substantially every possible broadcast) over the broadcast channel in block 402. In some embodiments, the timing of the possible broadcasts may be determined from the broadcast channel information, and the selected time interval may be selected or determined based on the timing of the possible broadcasts. In some embodiments, the device processor may schedule one or more tune-aways to the broadcast channel based on a selected time interval. The selected time interval may be based on the broadcast channel information, such as the timing of the possible broadcasts. In some embodiments, the multi-subscription multi-standby communication device may not receive any broadcast data (e.g., any broadcast data segments or other data) at an expected reception time (which may be based on the broadcast channel information). As a fallback mechanism, to ensure that the multi-subscription multi-standby communication device receives broadcast channel data, the device processor may schedule one or more tune-aways to the broadcast channel to receive every possible broadcast (or most of the broadcasts, or substantially every possible broadcast) over the broadcast channel. The device processor may then perform tune-aways to the broadcast channel per the schedule in block 320.

In determination block 404, the device processor may determine whether the multi-subscription multi-standby communication device has already received broadcast channel data that is anticipated or expected in the next scheduled cell broadcast in determination block 404. For example, since a communication network may repeatedly transmit the same broadcast data in a sequence of blocks, the device processor may determine the sequence number of each received sequence block of broadcast data, and use the sequence number to determine whether the multi-subscription multi-standby communication device has already received a block of data that is anticipated in the next scheduled cell broadcast.

In response to determining that the multi-subscription multi-standby communication device has received (i.e., already received) broadcast channel data that is anticipated in the next scheduled cell broadcast (i.e., determination block 404=“Yes”), the device processor may not perform, or may prevent the performance of, the next scheduled tune-away in block 406 (i.e., the multi-subscription multi-standby communication device may skip the next scheduled tune-away to the second network). The device processor may again determine whether the multi-subscription multi-standby communication device has received a block of data that is anticipated in the next scheduled cell broadcast in determination block 404.

In response to determining that the multi-subscription multi-standby communication device has not received the broadcast channel data that is anticipated in the next scheduled cell broadcast (i.e., determination block 404=“No”), the device processor may receive broadcast channel information from the second network in block 302, and may repeat the operations of blocks 302-406 as described.

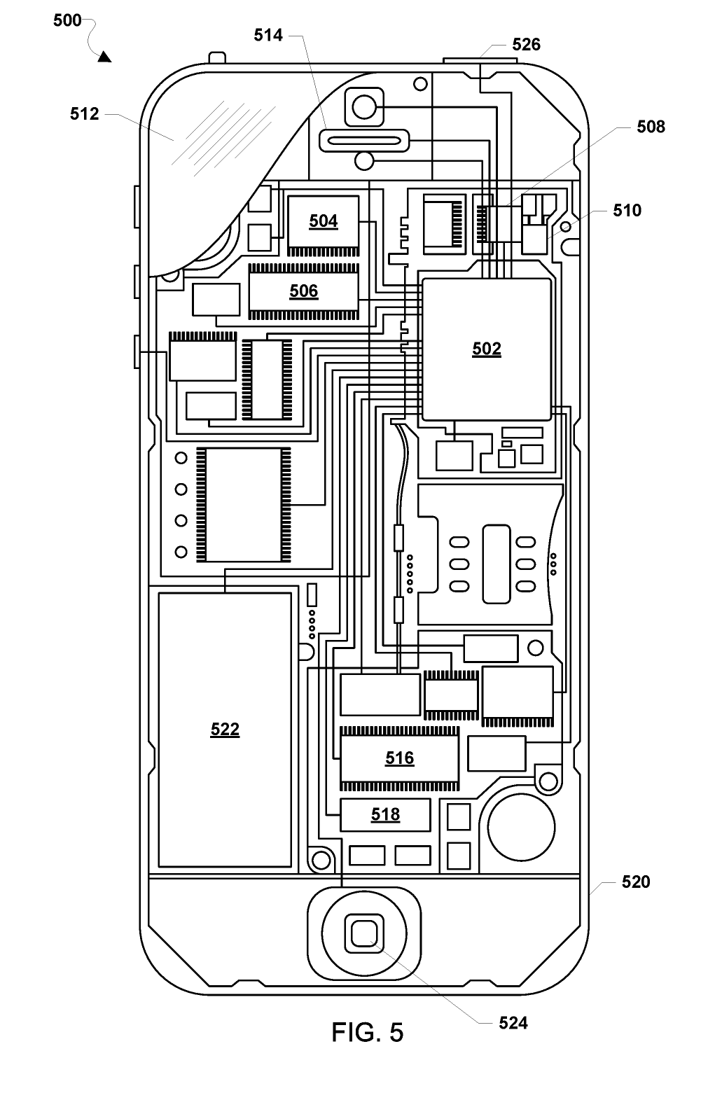

Various embodiments (including, but not limited to, embodiments described with reference to FIGS. 1-4) may be implemented in any of a variety of mobile communication devices, an example of which (e.g., mobile communication device 500) is illustrated in FIG. 5. In various embodiments, the mobile communication device 500 (which may correspond, for example, to the multi-subscription multi-standby communication devices 102 and 200 in FIGS. 1 and 2) may include a processor 502 coupled to a touchscreen controller 504 and an internal memory 506. The processor 502 may be one or more multi-core integrated circuits designated for general or specific processing tasks. The internal memory 506 may be volatile or non-volatile memory, and may also be secure and/or encrypted memory, or unsecure and/or unencrypted memory, or any combination thereof. The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the mobile communication device 500 need not have touch screen capability.

The mobile communication device 500 may have two or more radio signal transceivers 508 (e.g., Peanut, Bluetooth, Zigbee, Wi-Fi, RF radio) and antennae 510, for sending and receiving communications, coupled to each other and/or to the processor 502. The transceivers 508 and antennae 510 may be used with the above-mentioned circuitry to implement the various wireless transmission protocol stacks and interfaces. The mobile communication device 500 may include one or more cellular network wireless modem chip(s) 516 coupled to the processor and antennae 510 that enables communication via two or more cellular networks via two or more radio access technologies.

The mobile communication device 500 may include a peripheral device connection interface 518 coupled to the processor 502. The peripheral device connection interface 518 may be singularly configured to accept one type of connection, or may be configured to accept various types of physical and communication connections, common or proprietary, such as USB, FireWire, Thunderbolt, or PCIe. The peripheral device connection interface 518 may also be coupled to a similarly configured peripheral device connection port (not shown).

The mobile communication device 500 may also include speakers 514 for providing audio outputs. The mobile communication device 500 may also include a housing 520, constructed of a plastic, metal, or a combination of materials, for containing all or some of the components discussed herein. The mobile communication device 500 may include a power source 522 coupled to the processor 502, such as a disposable or rechargeable battery. The rechargeable battery may also be coupled to the peripheral device connection port to receive a charging current from a source external to the mobile communication device 500. The mobile communication device 500 may also include a physical button 524 for receiving user inputs. The mobile communication device 500 may also include a power button 526 for turning the mobile communication device 500 on and off.

The processor 502 may be any programmable microprocessor, microcomputer or multiple processor chip or chips that can be configured by software instructions (applications) to perform a variety of functions, including the functions of various embodiments described below. In some mobile communication devices, multiple processors 502 may be provided, such as one processor dedicated to wireless communication functions and one processor dedicated to running other applications. Typically, software applications may be stored in the internal memory 506 before they are accessed and loaded into the processor 502. The processor 502 may include internal memory sufficient to store the application software instructions.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, the various embodiments are not intended to be limited to the embodiments shown herein but are to be accorded the widest scope consistent with the following claims and the principles and novel features disclosed herein.

What is claimed is:

1. A method for managing tune-aways performed by a processor of a multi-subscription multi-standby communication device, the method comprising:
determining whether the multi-subscription multi-standby communication device is conducting an active communication session on a first network;
determining whether broadcast channel data is received over a broadcast channel of a second network in response to determining the multi-subscription multi-standby communication device is conducting the active communication session on the first network;
determining whether a periodicity of a broadcast of a broadcast of the broadcast channel data can be calculated in response to determining that the broadcast channel data is received over the broadcast channel;
calculating the periodicity of the broadcast of the broadcast channel data, based on a difference in arrival times of two or more blocks of received broadcast channel data, in response to determining that the periodicity of the broadcast can be calculated;
scheduling one or more tune-aways from the first network to the broadcast channel of the second network based on the calculated periodicity of the broadcast; and
performing the one or more tune-aways from the first network to the broadcast channel of the second network.

2. The method of claim 1, further comprising scheduling one or more tune-aways from the first network to the broadcast channel of the second network using a selected time interval in response to determining that the periodicity of the broadcast of the broadcast channel data cannot be calculated.

3. The method of claim 1, further comprising:
determining whether the multi-subscription multi-standby communication device has received broadcast channel data of a next-scheduled tune-away from the first network to the broadcast channel of the second network; and
preventing the next-scheduled tune-away in response to determining that the multi-subscription multi-standby communication device has received the broadcast channel data of the next-scheduled tune-away.

4. The method of claim 1, further comprising receiving every broadcast of the broadcast channel in response to determining that the multi-subscription multi-standby communication device is not conducting the active communication session on the first network.

5. The method of claim 1, further comprising scheduling one or more tune-aways from the first network to the broadcast channel of the second network to receive most broadcasts of the broadcast channel.

6. A multi-subscription multi-standby communication device, comprising:
a memory;
a radio frequency resource; and
a processor coupled to the memory and the radio frequency resource and configured with processor-executable instructions to:
determine whether the multi-subscription multi-standby communication device is conducting an active communication session on a first network;
determine whether broadcast channel data is received over a broadcast channel of a second network in response to determining the multi-subscription multi-standby communication device is conducting the active communication session on the first network;
determine whether a periodicity of a broadcast rate of a broadcast of the broadcast channel data can be calculated in response to determining that the broadcast channel data is received over the broadcast channel;
calculate the periodicity of the broadcast channel data, based on a difference in arrival times of two or more blocks of receive broadcast channel data, in response to determining that the periodicity of the broadcast can be calculated;
schedule one or more tune-aways from the first network to the broadcast channel of the second network based on the calculated periodicity of the broadcast;
perform the one or more tune-aways from the first network to the broadcast channel of the second network.

7. The multi-subscription multi-standby communication device of claim 6, wherein the processor is further configured with processor-executable instructions to schedule one or more tune-aways from the first network to the broadcast channel of the second network using a selected time interval in response to determining that the periodicity of the broadcast cannot be calculated.

8. The multi-subscription multi-standby communication device of claim 6, wherein the processor is further configured with processor-executable instructions to:
determine whether the multi-subscription multi-standby communication device has received broadcast channel data of a next-scheduled tune-away from the first network to the broadcast channel of the second network; and
prevent the next-scheduled tune-away in response to determining that the multi-subscription multi-standby communication device has received the broadcast channel data of the next-scheduled tune-away.

9. The multi-subscription multi-standby communication device of claim 6, wherein the processor is further configured with processor-executable instructions to receive every broadcast of the broadcast channel in response to determining that the multi-subscription multi-standby communication device is not conducting the active communication session on the first network.

10. The multi-subscription multi-standby communication device of claim 6, wherein the processor is further configured with processor-executable instructions to schedule one or more tune-aways from the first network to the broadcast channel of the second network to receive most broadcasts of the broadcast channel.

11. A non-transitory processor-readable storage medium having stored thereon processor-executable instructions configured to cause a processor of a multi-subscription multi-standby communication device to perform operations comprising:
determining whether the multi-subscription multi-standby communication device is conducting an active communication session on a first network;
determining whether broadcast channel data is received over a broadcast channel of a second network in response to determining the multi-subscription multi-standby communication device is conducting the active communication session on the first network;
determining whether a periodicity of a broadcast of the broadcast channel data can be calculated in response to determining that the broadcast channel data is received over the broadcast channel;
calculating the periodicity of the broadcast of the broadcast channel data, based on a difference in arrival times of two or more blocks of received broadcast channel data, in response to determining that the periodicity of the broadcast can be calculated;
scheduling one or more tune-aways from the first network to the broadcast channel of the second network based on the calculated periodicity of the broadcast; and
performing the one or more tune-aways from the first network to the broadcast channel of the second network.

12. The non-transitory processor-readable storage medium of claim 11, wherein the stored processor-executable instructions are configured to cause the processor of the multi-subscription multi-standby communication device to perform operations further comprising scheduling one or more tune-aways from the first network to the broadcast channel of the second network using a selected time interval in response to determining that the periodicity of the broadcast cannot be calculated.

13. The non-transitory processor-readable storage medium of claim 11, wherein the stored processor-executable instructions are configured to cause the processor of the multi-subscription multi-standby communication device to perform operations further comprising:
determining whether the multi-subscription multi-standby communication device has received broadcast channel data of a next-scheduled tune-away; and
preventing the next-scheduled tune-away in response to determining that the multi-subscription multi-standby communication device has received the broadcast channel data of the next-scheduled tune-away.

14. The non-transitory processor-readable storage medium of claim 11, wherein the stored processor-executable instructions are configured to cause the processor of the multi-subscription multi-standby communication device to perform operations further comprising receiving every broadcast of the broadcast channel in response to determining that the multi-subscription multi-standby communication device is not conducting the active communication session on the first network.

15. The non-transitory processor-readable storage medium of claim 11, wherein the stored processor-executable instructions are configured to cause the processor of the multi-subscription multi-standby communication device to perform operations further comprising scheduling one or more tune-aways from the first network to the broadcast channel of the second network to receive most broadcasts of the broadcast channel.

16. A multi-subscription multi-standby communication device, comprising:
means for determining whether the multi-subscription multi-standby communication device is conducting an active communication session on a first network;
means for determining whether broadcast channel data is received over a broadcast channel of a second network in response to determining the multi-subscription multi-standby communication device is conducting the active communication session on the first network;
means for determining whether a periodicity of a broadcast of the broadcast channel data can be calculated in response to determining that the broadcast channel data is received over the broadcast channel;
means for calculating the periodicity of the broadcast of the broadcast channel data, based on a difference in arrival times of two or more blocks of received broadcast channel data, in response to determining that the periodicity of the broadcast can be calculated;
means for scheduling one or more tune-aways from the first network to the broadcast channel of the second network based on the calculated periodicity of the broadcast; and
means for performing the one or more tune-aways from the first network to the broadcast channel of the second network.
